(19) United States
(12) Patent Application Publication
(10) Pub. No.: US 2014/0244639 A1
(43) Pub. Date: Aug. 28, 2014

(54) SURPRISAL DATA REDUCTION OF GENETIC DATA FOR TRANSMISSION, STORAGE, AND ANALYSIS

(71) Applicant: International Business Machines Corporation, Armonk, NY (US)

(72) Inventors: Robert R. Friedlander, Southbury, CT (US); James R. Kraemer, Santa Fe, NM (US)

(73) Assignee: International Business Machines Corporation, Armonk, NY (US)

(21) Appl. No.: 14/267,236

(22) Filed: May 1, 2014

Related U.S. Application Data
(63) Continuation of application No. 13/428,146, filed on Mar. 23, 2012.

(51) Int. Cl. G06F 19/22; G06F 19/28

(52) U.S. Cl. CPC G06F 19/22; G06F 19/28
USPC 707/736

(57) ABSTRACT

A method, computer product, and computer system of reducing an amount of data representing a genetic sequence of an organism, comprising: a computer comparing nucleotides of the genetic sequence of the organism to nucleotides from a reference genome, to find differences where nucleotides of the genetic sequence of the organism which are different from the nucleotides of the reference genome; the computer using the differences to create and store surprisal data in a repository, the surprisal data comprising a starting location of the differences within the reference genome, and the nucleotides from the genetic sequence of the organism which are different from the nucleotides of the reference genome, discarding sequences of nucleotides that are the same in the genetic sequence of the organism and the reference genome.

### CROSS-REFERENCE TO RELATED APPLICATIONS

This is a continuation of copending application Ser. No. 13/428,146, filed Mar. 23, 2012, entitled “SURPRISAL DATA REDUCTION OF GENETIC DATA FOR TRANSMISSION, STORAGE, AND ANALYSIS”. The aforementioned application is hereby incorporated herein by reference.

### BACKGROUND

The present invention relates to gene sequencing, and more specifically to surprisal data reduction of genetic data for transmission, storage, and analysis.

DNA gene sequencing of a human, for example, generates about 3 billion (3×10⁹) nucleotide bases. Currently all 3 billion nucleotide base pairs are transmitted, stored and analyzed. The storage of the data associated with the sequencing is significantly large, requiring at least 3 gigabytes of computer data storage space to store the entire genome which includes only nucleotide sequenced data and no other data or information such as annotations. The movement of the data between institutions, laboratories and research facilities is hindered by the significantly large amount of data and the significant amount of storage necessary to contain the data.

### SUMMARY

According to an embodiment of the present invention, a method of reducing an amount of data representing a genetic sequence of an organism. The method comprising: a computer comparing nucleotides of the genetic sequence of the organism to nucleotides from a reference genome, to find differences where nucleotides of the genetic sequence of the organism which are different from the nucleotides of the reference genome; the computer using the differences to create and store surprisal data in a repository, the surprisal data comprising a starting location of the differences within the reference genome, and the nucleotides from the genetic sequence of the organism which are different from the nucleotides of the reference genome, discarding sequences of nucleotides that are the same in the genetic sequence of the organism and the reference genome.

According to another embodiment of the present invention, a method of recreating an entire genome of the organism from a reference genome and surprisal data, the surprisal data comprising a starting location of the differences within the reference genome, and the nucleotides from the genetic sequence of the organism which are different from the nucleotides of the reference genome, discarding sequences of nucleotides that are the same in the genetic sequence of the organism and the reference genome. The method including the steps of: retrieving surprisal data from the repository;

retrieving a reference genome from the repository; and altering the reference genome based on the surprisal data by replacing nucleotides at each location in the reference genome specified by the surprisal data with the nucleotides from the genetic sequence of the organism in the surprisal data associated with the location; resulting in an entire genome of the organism.

According to one embodiment of the present invention, a computer program product for reducing an amount of data representing a genetic sequence of an organism. The computer program product comprising: one or more computer-readable, tangible storage devices; program instructions, stored on at least one of the one or more storage devices, to compare nucleotides of the genetic sequence of the organism to nucleotides from a reference genome, to find differences where nucleotides of the genetic sequence of the organism which are different from the nucleotides of the reference genome; program instructions, stored on at least one of the one or more storage devices, to use the differences to create and store surprisal data in a repository, the surprisal data comprising a starting location of the differences within the reference genome, and the nucleotides from the genetic sequence of the organism which are different from the nucleotides of the reference genome, discarding sequences of nucleotides that are the same in the genetic sequence of the organism and the reference genome.

According to one embodiment of the present invention, a computer program product for recreating an entire genome of the organism from a reference genome and surprisal data, the surprisal data comprising a starting location of the differences within the reference genome, and the nucleotides from the genetic sequence of the organism which are different from the nucleotides of the reference genome, discarding sequences of nucleotides that are the same in the genetic sequence of the organism and the reference genome. The computer program product comprising: one or more computer-readable, tangible storage devices; program instructions, stored on at least one of the one or more storage devices, to retrieve surprisal data from the repository; program instructions, stored on at least one of the one or more storage devices, to retrieve a reference genome from the repository; and program instructions, stored on at least one of the one or more storage devices, to alter the reference genome based on the surprisal data by replacing nucleotides at each location in the reference genome specified by the surprisal data with the nucleotides from the genetic sequence of the organism in the surprisal data associated with the location; resulting in an entire genome of the organism.

According to another embodiment of the present invention, a computer system for reducing an amount of data representing a genetic sequence of an organism. The computer system comprising: one or more processors, one or more computer-readable memories and one or more computer-readable, tangible storage devices; program instructions, stored on at least one of the one or more storage devices for execution by at least one of the one or more processors via at least one of the one or more memories, to compare nucleotides of the genetic sequence of the organism to nucleotides from a reference genome, to find differences where nucleotides of the genetic sequence of the organism which are different from the nucleotides of the reference genome; program instructions, stored on at least one of the one or more storage devices for execution by at least one of the one or more processors via at least one of the one or more memories, to use the differences to create and store surprisal data in a repository, the surprisal data comprising a starting location of the differences within the reference genome, and the nucleotides from the genetic sequence of the organism which are different from the nucleotides of the reference genome, discarding sequences of nucleotides that are the same in the genetic sequence of the organism and the reference genome.

According to another embodiment of the present invention, a computer system for recreating an entire genome of the organism from a reference genome and surprisal data, the surprisal data comprising a starting location of the differences within the reference genome, and the nucleotides from the genetic sequence of the organism which are different from the nucleotides of the reference genome, discarding sequences of nucleotides that are the same in the genetic sequence of the organism and the reference genome. The computer system comprising: one or more processors, one or more computer-readable memories and one or more computer-readable, tangible storage devices; program instructions, stored on at least one of the one or more storage devices for execution by at least one of the one or more processors via at least one of the one or more memories, to retrieve surprisal data from the repository; program instructions, stored on at least one of the one or more storage devices for execution by at least one of the one or more processors via at least one of the one or more memories, to retrieve a reference genome from the repository; and program instructions, stored on at least one of the one or more storage devices for execution by at least one of the one or more processors via at least one of the one or more memories, to alter the reference genome based on the surprisal data by replacing nucleotides at each location in the reference genome specified by the surprisal data with the nucleotides from the genetic sequence of the organism in the surprisal data associated with the location; resulting in an entire genome of the organism.

### BRIEF DESCRIPTION OF THE SEVERAL VIEWS OF THE DRAWINGS

FIG. 1 depicts an exemplary diagram of a possible data processing environment in which illustrative embodiments may be implemented.

FIG. 2 shows a flowchart of a method of data surprisal data reduction of genetic data for transmission, storage, and analysis according to an illustrative embodiment.

FIG. 3 shows a schematic of the comparison of an organism gene sequence to a reference genome sequence to obtain surprisal data.

FIG. 4 shows a schematic of the recreation of an organism genome sequence using a reference genome sequence and surprisal data.

FIG. 5 shows a schematic overview of a method of data surprisal data reduction of genetic data for transmission, storage, and analysis according to an illustrative embodiment.

FIG. 6 illustrates internal and external components of a client computer and a server computer in which illustrative embodiments may be implemented.

### DETAILED DESCRIPTION

The illustrative embodiments of the present invention recognize that the difference between the genetic sequence from two humans is about 0.1%, which is one nucleotide difference per 1000 base pairs or approximately 3 million nucleotide differences. The difference may be a single nucleotide polymorphism (SNP) (a DNA sequence variation occurring when a single nucleotide in the genome differs between members of a biological species), or the difference might involve a sequence of several nucleotides. The illustrative embodiments recognize that most SNPs are neutral but some, 3-5% are functional and influence phenotypic differences between species through alleles. Furthermore that approximately 10 to 30 million SNPs exist in the human population of which at least 1% are functional. The illustrative embodiments also recognize that with the small amount of differences present between the genetic sequence from two humans, the “common” or “normally expected” sequences of nucleotides can be compressed out or removed to arrive at “surprisal data”—differences of nucleotides which are “unlikely” or “surprising” relative to the common sequences. The dimensionality of the data reduction that occurs by removing the “common” sequences is 10³, such that the number of data items and, more important, the interaction between nucleotides, is also reduced by a factor of approximately 10³—that is, to a total number of nucleotides remaining is on the order of 10³. The illustrative embodiments also recognize that by identifying what sequences are “common” or provide a “normally expected” value within a genome, and knowing what data is “surprising” or provides an “unexpected value” relative to the normally expected value, the only data needed to recreate the entire genome in a lossless manner is the surprisal data and the genome used to obtain the surprisal data.

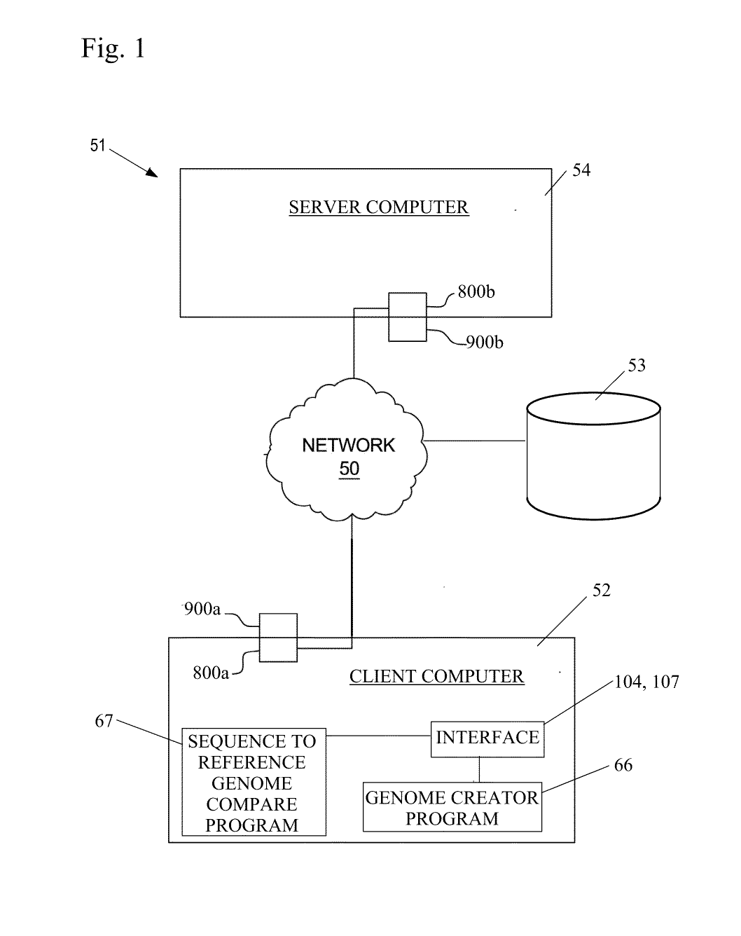

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

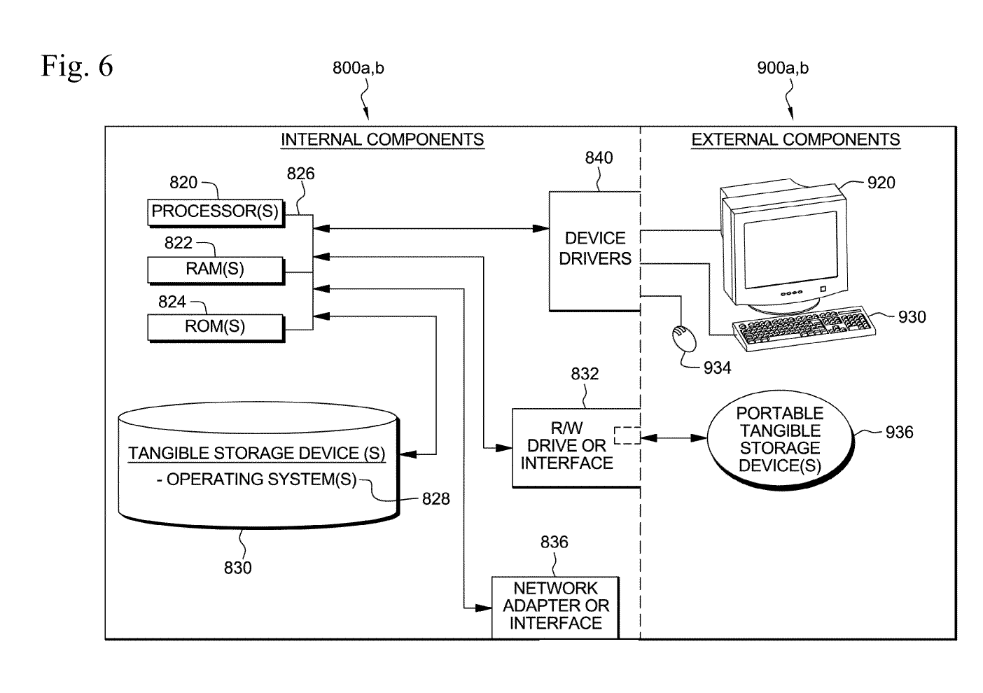

In the depicted example, client computer 52, storage unit 53, and server computer 54 connect to network 50. In other exemplary embodiments, network data processing system 51 may include additional client computers, storage devices, server computers, and other devices not shown. Client computer 52 includes a set of internal components 800a and a set of external components 900a, further illustrated in FIG. 6. Client computer 52 may be, for example, a mobile device, a cell phone, a personal digital assistant, a netbook, a laptop computer, a tablet computer, a desktop computer, or any other type of computing device.

Client computer 52 may contain an interface 104. Through the interface 104, different reference genomes and surprisal data may be viewed by users. The interface 104 may accept commands and data entry from a user. The interface 104 can be, for example, a command line interface, a graphical user interface (GUI), or a web user interface (WUI) through which a user can access a sequence to reference genome compare program 67 and/or a genome creator program 66 on client computer 52, as shown in FIG. 1, or alternatively on server computer 54. Server computer 54 includes a set of internal components 800b and a set of external components 900b illustrated in FIG. 6.

In the depicted example, server computer 54 provides information, such as boot files, operating system images, and applications to client computer 52. Server computer 54 can compute the information locally or extract the information from other computers on network 50.

Program code, reference genomes, and programs such as a sequence to reference genome compare program 67 and/or a genome creator program 66 may be stored on at least one of one or more computer-readable tangible storage devices 830 shown in FIG. 6, on at least one of one or more portable computer-readable tangible storage devices 936 as shown in FIG. 6, on storage unit 53 connected to network 50, or downloaded to a data processing system or other device for use. For example, program code, reference genomes, and programs such as a sequence to reference genome compare program 67 and/or a genome creator program 66 may be stored on at least one of one or more tangible storage devices 830 on server computer 54 and downloaded to client computer 52 over network 50 for use on client computer 52. Alternatively, server computer 54 can be a web server, and the program code, reference genomes, and programs such as a sequence to reference genome compare program 67 and/or a genome creator program 66 may be stored on at least one of the one or more tangible storage devices 830 on server computer 54 and accessed on client computer 52. Sequence to reference genome compare program 67 and/or genome creator program 66 can be accessed on client computer 52 through interface 104. In other exemplary embodiments, the program code, reference genomes, and programs such as sequence to reference genome compare program 67 and genome creator program 66 may be stored on at least one of one or more computer-readable tangible storage devices 830 on client computer 52 or distributed between two or more servers.

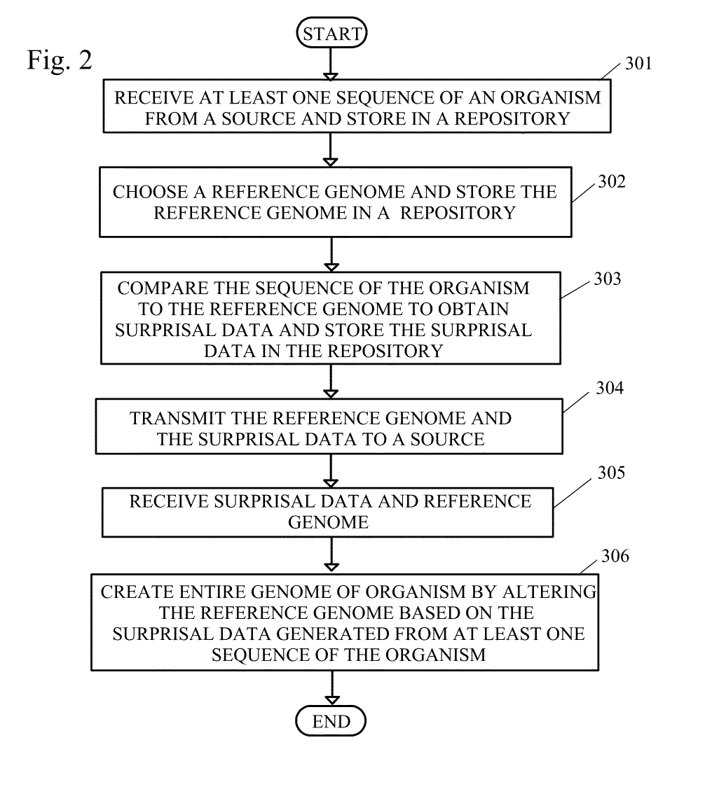

FIG. 2 shows a flowchart of a method of data surprisal data reduction of genetic data for transmission, storage, and analysis according to an illustrative embodiment.

In a first step, the sequence to reference genome compare program 67 receives at least one sequence of an organism from a source and stores the at least one sequence in a repository (step 301). The repository may be repository 53 as shown in FIG. 1. The source may be a sequencing device. The sequence may be a DNA sequence, an RNA sequence, or a nucleotide sequence. The organism may be a fungus, microorganism, human, animal or plant.

Based on the organism from which the at least one sequence is taken, the sequence to reference genome compare program 67 chooses and obtains at least one reference genome and stores the reference genome in a repository (step 302).

A reference genome is a digital nucleic acid sequence database which includes numerous sequences. The sequences of the reference genome do not represent any one specific individual's genome, but serve as a starting point for broad comparisons across a specific species, since the basic set of genes and genomic regulator regions that control the development and maintenance of the biological structure and processes are all essentially the same within a species. In other words, the reference genome is a representative example of a species' set of genes.

The reference genome may be tailored depending on the analysis that may take place after obtaining the surprisal data. For example, the sequence to reference genome compare program 67 can limit the comparison to specific genes of the reference genome, ignoring other genes or more common single nucleotide polymorphisms that may occur in specific populations of a species.

The sequence to reference genome compare program 67 compares the at least one sequence to the reference genome to obtain surprisal data and stores only the surprisal data in a repository 53 (step 303). The surprisal data is defined as at least one nucleotide difference that provides an “unexpected value” relative to the normally expected value of the reference genome sequence. In other words, the surprisal data contains at least one nucleotide difference present when comparing the sequence to the reference genome sequence. The surprisal data that is actually stored in the repository preferably includes a location of the difference within the reference genome, the number of nucleic acid bases that are different, and the actual changed nucleic acid bases. Storing the number of bases which are different provides a double check of the method by comparing the actual bases to the reference genome bases to confirm that the bases really are different.

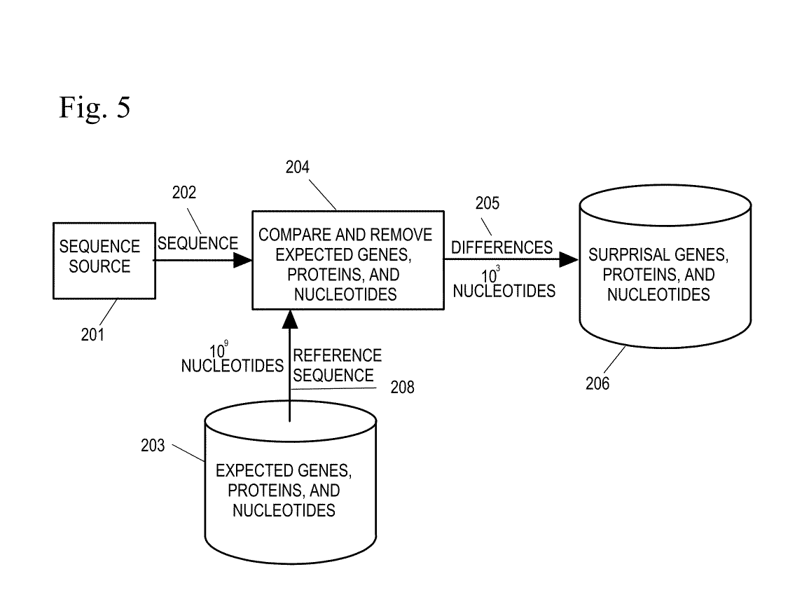

FIG. 5 provides an overview of the method of data surprisal data reduction of genetic data for transmission, storage and analysis. Referring to that figure, a sequence source 201 sends at least one sequence 202. A reference genome 203 of expected genes, proteins, and nucleotides provides a reference sequence 208. The reference genome 203 contains approximately 10⁹ nucleotides, from which the reference sequence 208 is selected.

The sequence 202 is compared 204 to the reference sequence 208, for example by the sequence to reference genome compare program 67 in FIG. 1, and the expected genes, proteins, and nucleotides are removed. The difference information 205, after removal of the expected genes, proteins and nucleotides, is stored as surprisal genes, proteins, and nucleotides 206. This compare-and-remove operation 204 reduces the 109 nucleotides in the reference 208 down to 10³ nucleotides in the difference 205.

For example, in the case of the human genome, which is 3 billion base pairs long and requires at least 3 gigabytes of computer data storage space, not including any other information such as annotations or other meta-data, the present invention reduces the size of the stored base pairs by 1,000 times to only 3 million surprisal base pairs, which may be stored in approximately 3 kilobytes worth of data storage, thus significantly reducing the amount computer data storage space needed. Other compression techniques well known in the art may be used in addition to compress the data.

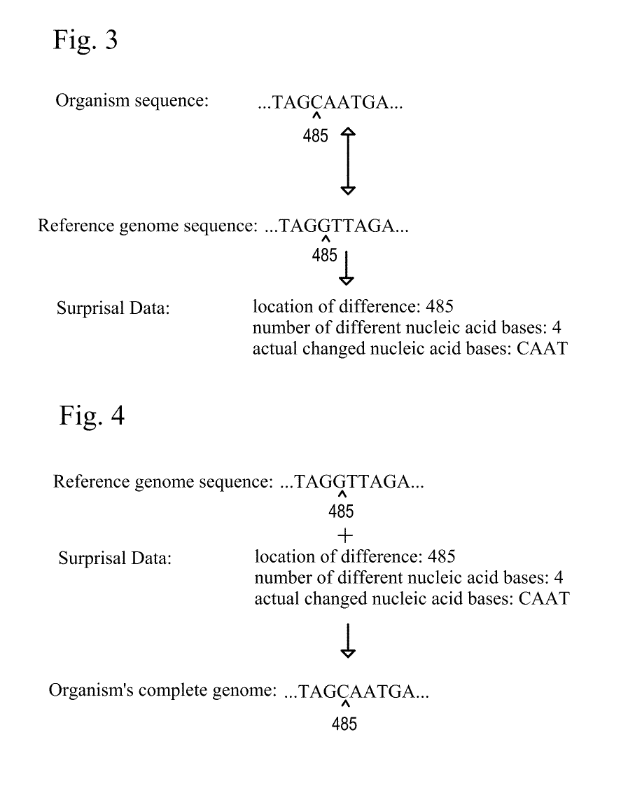

FIG. 3 shows a schematic of the comparison of an organism sequence to a reference genome sequence to obtain surprisal data. The surprisal data that results from the comparison preferably consists of a location of a difference in the reference genome, the number of bases that were different at the location within the reference genome, and the actual bases that are different than bases in the reference genome at the location. For example, the surprisal data that resulted from comparing the organism sequence to the reference genome shown in FIG. 3 would be surprisal data consisting of: a difference at location 485 of the reference genome; four nucleic acid base differences relative to the reference genome, and the actual bases present in the sequence at the location, for example CAAT (instead of GTTA). The surprisal data and reference genome may be stored on a hard disk.

It should be noted that in FIGS. 3 and 4, only a portion of both the organism sequence and the reference genome are shown for clarity, and the sequences shown are chosen randomly and do not represent a real DNA sequence of any sort.

Referring to FIG. 4, the surprisal data and the reference genome are then transmitted to a source (step 304, FIG. 2). The source may be the same source in which the sequence of the organism was received or a different source. The reference genome itself may be transmitted or a location or index key of the reference genome in the repository may be transmitted.

The transmitted reference genome and the surprisal data are received by the source (step 305, FIG. 2). If only the location or index key of the reference genome was transmitted, a genome creator program 66 can obtain the reference genome from the repository.

Using the transmitted reference genome and the surprisal data, the genome creator program 66 (FIG. 1) finds a location within the reference genome that was indicated as having a difference in the surprisal data and alters the bases of the reference genome to be the bases indicated by the surprisal data. In the example of FIG. 4, based on the surprisal data, a difference is present at location 485, this location is found in the reference genome and GTTA is changed to be CAAT as indicated by the surprisal data. Once all alterations to the reference genome have been made based on the surprisal data, the genome creator program 66 (FIG. 1) then creates an entire genome of an organism by altering the reference genome based on the surprisal data which was generated from a sequence from the organism (step 306, FIG. 2) in a lossless manner.

The surprisal data may be verified by comparing the nucleotides from the genetic sequence of the organism in the surprisal data to the nucleotides in the reference genome at the location. If all of the nucleotides in the surprisal data are different from the nucleotides in the reference genome the surprisal data is verified.

FIG. 6 illustrates internal and external components of client computer 52 and server computer 54 in which illustrative embodiments may be implemented. In FIG. 6, client computer 52 and server computer 54 include respective sets of internal components 800a, 800b, and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828, sequence to reference genome compare program 67 and genome creator program 66 are stored on one or more of the computer-readable tangible storage devices 830 for execution by one or more of the processors 820 via one or more of the RAMs 822 (which typically include cache memory). In the embodiment illustrated in FIG. 6, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device. Sequence to reference genome compare program 67 and genome creator program 66 can be stored on one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. Sequence to reference genome compare program 67 or genome creator program 66 can be downloaded to computer 52 and server computer 54 from an external computer via a network (for example, the Internet, a local area network or other, wide area network) and network adapter or interface 836. From the network adapter or interface 836, sequence to reference genome compare program 67 and genome creator program 66 are loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 934. Each of the sets of internal components 800a, 800b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Sequence to reference genome compare program 67 and genome creator program 66 can be written in various programming languages including low-level, high-level, object-oriented or non object-oriented languages. Alternatively, the functions of a sequence to reference genome compare program 67 and genome creator program 66 can be implemented in whole or in part by computer circuits and other hardware (not shown).

Based on the foregoing, a computer system, method and program product have been disclosed for surprisal data reduction of genetic data for transmission, storage, and analysis. However, numerous modifications and substitutions can be made without deviating from the scope of the present invention. Therefore, the present invention has been disclosed by way of example and not limitation.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method of reducing an amount of data representing a genetic sequence of an organism, comprising:
comparing nucleotides of the genetic sequence of the organism to nucleotides from a reference genome by a computer, to find single nucleotide polymorphism differences where nucleotides of the genetic sequence of the organism are different from the nucleotides of the reference genome;
using the differences to create and store surprisal data in a repository by a computer, the surprisal data comprising a starting location of the single nucleotide polymorphism differences within the reference genome, and the nucleotides from the genetic sequence of the organism which are different from the nucleotides of the reference genome, discarding sequences of nucleotides that are the same in the genetic sequence of the organism and the reference genome; and
re-creating an entire genome of the organism by the computer:
retrieving surprisal data from the repository;
retrieving a reference genome from the repository;
verifying the surprisal data by the computer by determining that the surprisal data is verified if the number of differences is equal to the number of nucleotides in the surprisal data; and
altering the reference genome based on the surprisal data by replacing nucleotides at each location in the reference genome specified by the surprisal data with the single nucleotide polymorphism differences from the genetic sequence of the organism in the surprisal data associated with the location; resulting in an entire genome of the organism.

2. The method of claim 1, wherein the organism is human.

3. The method of claim 1, further comprising a computer receiving at least one sequence of an organism from a source and storing the at least one sequence in a repository.

4. The method of claim 1, further comprising a computer obtaining a reference genome corresponding to the organism and storing the reference genome in a repository.

5. The method of claim 1, in which the surprisal data further comprises a number of single nucleotide polymorphism differences at the location within the reference genome.

6. The method of claim 1, wherein the organism is an animal.

7. The method of claim 1, wherein the organism is a microorganism.

8. The method of claim 1, wherein the organism is a plant.

9. The method of claim 1, wherein the organism is a fungus.

10. A computer program product for reducing an amount of data representing a genetic sequence of an organism, wherein program instructions are stored on one or more computer-readable storage devices and are executed on a computer, the computer program product comprising:
program instructions, stored on at least one of the one or more storage devices, to compare nucleotides of the genetic sequence of the organism to nucleotides from a reference genome, to find single nucleotide polymorphism differences where nucleotides of the genetic sequence of the organism are different from the nucleotides of the reference genome;
program instructions, stored on at least one of the one or more storage devices, to use the differences to create and store surprisal data in a repository, the surprisal data comprising a starting location of the single nucleotide polymorphism differences within the reference genome, and the nucleotides from the genetic sequence of the organism which are different from the nucleotides of the reference genome, discarding sequences of nucleotides that are the same in the genetic sequence of the organism and the reference genome; and
program instructions, stored on at least one of the one or more storage devices, to recreate an entire genome of the organism by:
retrieving surprisal data from the repository;
retrieving a reference genome from the repository;
verifying the surprisal data by determining that the surprisal data is verified if the number of differences is equal to the number of nucleotides in the surprisal data; and
altering the reference genome based on the surprisal data by replacing nucleotides at each location in the reference genome specified by the surprisal data with the single nucleotide polymorphism differences from the genetic sequence of the organism in the surprisal data associated with the location; resulting in an entire genome of the organism.

11. The computer program product of claim 10, wherein the organism is human.

12. The computer program product of claim 10, further comprising program instructions, stored on at least one of the one or more storage devices, to receive at least one sequence of an organism from a source and store the at least one sequence in a repository.

13. The computer program product of claim 10, further comprising program instructions, stored on at least one of the one or more storage devices, to obtain a reference genome corresponding to the organism and store the reference genome in a repository.

14. A computer system for reducing an amount of data representing a genetic sequence of an organism, comprising:
one or more processors, one or more computer-readable memories and one or more computer-readable storage devices;
program instructions, stored on at least one of the one or more storage devices for execution by at least one of the one or more processors via at least one of the one or more memories, to compare nucleotides of the genetic sequence of the organism to nucleotides from a reference genome, to find single nucleotide polymorphism differences where nucleotides of the genetic sequence of the organism are different from the nucleotides of the reference genome;
program instructions, stored on at least one of the one or more storage devices for execution by at least one of the one or more processors via at least one of the one or more memories, to use the differences to create and store surprisal data in a repository, the surprisal data comprising a starting location of the single nucleotide polymorphism differences within the reference genome, and the nucleotides from the genetic sequence of the organism which are different from the nucleotides of the reference genome, discarding sequences of nucleotides that are the same in the genetic sequence of the organism and the reference genome; and
program instructions, stored on at least one of the one or more storage devices for execution by at least one of the one or more processors via at least one of the one or more memories, to recreate an entire genome of the organism by:
retrieving surprisal data from the repository;
retrieving a reference genome from the repository;
verifying the surprisal data by determining that the surprisal data is verified if the number of differences is equal to the number of nucleotides in the surprisal data; and
altering the reference genome based on the surprisal data by replacing nucleotides at each location in the reference genome specified by the surprisal data with the single nucleotide polymorphism difference from the genetic sequence of the organism in the surprisal data associated with the location; resulting in an entire genome of the organism.

15. The computer system of claim 14, wherein the organism is human.

16. The computer system of claim 14, further comprising program instructions, stored on at least one of the one or more storage devices for execution by at least one of the one or more processors via at least one of the one or more memories, to receive at least one sequence of an organism from a source and store the at least one sequence in a repository.

17. The computer system of claim 14, further comprising program instructions, stored on at least one of the one or more storage devices for execution by at least one of the one or more processors via at least one of the one or more memories, to obtain a reference genome corresponding to the organism and store the reference genome in a repository.
